(19) United States
(12) Patent Application Publication
(10) Pub. No.: US 2009/0320439 A1
(43) Pub. Date: Dec. 31, 2009

(54) PULSED DETONATION COMBUSTOR CLEANING DEVICE AND METHOD OF OPERATION

(75) Inventors: David Michael Chapin, Niskayuna, NY (US); Anthony John Dean, Scotia, NY (US); Terry Lewis Farmer, Kearney, MO (US); James Knox Shelton, Jacksonville, AL (US); Alan Wesley Bixler, Olathe, KS (US); Vincent Paul Berreto, Blue Springs, MO (US); Justin Thomas Brumberg, Colonie, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/669,582

(22) Filed: Jan. 31, 2007

Related U.S. Application Data
(60) Provisional application No. 60/763,563, filed on Jan. 31, 2006.

(51) Int. Cl. F02C 5/02; B08B 7/00

(52) U.S. Cl. 60/39.38; 134/19

(57) ABSTRACT

A pulse detonation cleaner system is described. The cleaner includes an elongated combustion chamber configured with at least one fuel injection inlet and one air inlet to provide fuel to the combustion chamber. The fuel and air are mixed and ignited to produce a flame. The flame is accelerated into a detonation as it propagates downstream through the combustion chamber. The detonation and its products are vented from the combustion chamber into a vessel to be cleaned. The shock and high-pressure products of the detonation are used to release debris from the walls of the vessel and blow them away.

### RELATED CASES

This application claims priority under 35 U.S.C. §119(e) from Provisional Application No. 60/763,563 filed on 31 Jan. 2006.

### BACKGROUND

The systems and techniques described herein relate generally to a cyclic pulsed detonation combustion cleaner. More specifically, they relate to removal of buildup on surfaces within various sections of an industrial boiler system using impulses generated from pulsed detonations.

Industrial boilers operate by using a heat source to create steam from water or another working fluid, which can then be used to drive a turbine in order to supply power. The heat source may be a combustor that burns a fuel in order to generate heat, which is then transferred into the working fluid via a heat exchanger. Burning the fuel may generate residues that can be left behind on the surface of the combustor or heat exchanger. Such buildups of soot, ash, slag, or dust on heat exchanger surfaces can inhibit the transfer of heat and therefore decrease the efficiency of the system. Periodic removal of such built-up deposits maintains the efficiency of such boiler systems.

In the past, pressurized steam, water jets, acoustic waves, and mechanical hammering have been used to remove this buildup. These systems can be costly to maintain, and effectiveness of these devices varies depending on location and use. More recently, the use of detonative combustion devices has been attempted to remove buildup. These systems tend to require a large footprint, operate infrequently, and in some cases require oxygen enrichment in order to create the detonations.

Therefore, there is a continued need for development of effective detonative combustion cleaning systems.

### BRIEF DESCRIPTION

Briefly, in accordance with one aspect of the systems described herein, a system for removing accumulated debris from a surface within a vessel is provided. The system includes a vessel that has a surface to be cleaned, a fuel source to provide a combustible fuel, an air source to provide a flow of air and a pulse detonation combustor. The combustor includes a combustion chamber that has a wall that defines an airflow path from an upstream end toward a downstream end, an air inlet disposed upon the combustion chamber and connected to the air source and in flow communication with the combustion chamber, a fuel inlet in flow communication with the combustion chamber and connected to the fuel source, an ignition device disposed downstream of the fuel inlet that is configured to periodically ignite the fuel within the airflow and produce a flame, and a plurality of obstacles disposed along the airflow path and configured to promote the acceleration of the flame into a detonation as it passes through the combustion chamber. The downstream end of the pulse detonation combustor is disposed on the vessel such that the shock wave associated with the detonation from the pulse detonation combustor passes over the surface to be cleaned within the vessel.

In accordance with another aspect of the systems described herein, a cleaner for removing accumulated debris from a surface of a vessel is provided. The cleaner includes a pulse detonation combustor as described above, and the downstream end of the pulse detonation combustor is configured to direct the shock wave associated with the detonation in the pulse detonation combustor to pass over the surface of a vessel to be cleaned.

In accordance with an aspect of the techniques described herein, a method for removing accumulated debris from a surface within a vessel is described. The method includes the steps of receiving a flow of air into a combustion chamber through an air inlet, the flow of air defining a downstream direction of flow. Another step includes receiving a flow of fuel into the combustion chamber through a fuel inlet into the flow of air. Other steps include mixing the fuel and air within the combustion chamber and periodically igniting the fuel and air mixture using an ignition device. Another step includes accelerating the flame into a detonation as it passes downstream through the combustion chamber by passing the flow over a plurality of obstacles disposed along the path of the flow of air through the combustion chamber. Other steps include directing the detonation into a vessel having a surface to be cleaned and passing the shockwave associated with the detonation over a surface within a vessel to loosen debris from the surface. The method also includes blowing the loosened debris from the surface.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a pulse detonation combustor system in accordance with one aspect of the systems described herein;

FIG. 2 is a schematic representation of an alternate head end for a pulse detonation combustor in accordance with another embodiment of the systems described herein;

FIG. 3 is a schematic representation of an embodiment of a diverging chamber for use with the pulse detonation combustors described herein;

FIG. 4 is a schematic axial view of an annular ring obstacle for use within a pulse detonation combustor as described herein;

FIG. 5 is a schematic axial view of a circular segment obstacle for use within a pulse detonation combustor as described herein;

FIG. 6 is a schematic axial view of a crescent-shaped obstacle for use within a pulse detonation combustor as described herein;

FIG. 7 is a schematic representation of an alternate embodiment of a combustion chamber for use in a PDC-based cleaner as described herein;

FIG. 8 is a schematic cross-sectional axial view of a bolt used as an obstacle within a pulse detonation combustor as described herein;

FIG. 9 is a schematic representation of a bent combustion chamber for use in a pulse detonation combustor as described herein;

FIG. 10 is a schematic representation of a PDC-based cleaner extending into the interior of an exemplary boiler as described herein;

FIG. 11 is a multiple exit chamber for use in one embodiment of a PDC-based cleaner as described herein; and

FIG. 12 is an alternate arrangement of a multiple exit cleaner disposed within an exemplary boiler vessel in accordance with the systems described herein.

### DETAILED DESCRIPTION

As discussed above, soot or other buildup on heat exchanger surfaces in industrial boilers can cause losses in the overall system efficiency due to a reduction in the amount of heat that is actually transferred into the working fluid. This is often reflected by an increase in the exhaust gas temperature from the backend of the process, as well as an increase in the fuel-burn rate required to maintain steam production and energy output. Traditionally, the complete removal of buildup from such fouled surfaces requires the boiler to be shut down while the cleaning process is performed. Online cleaning techniques generally lead to high maintenance costs or incomplete cleaning results.

In the systems and techniques described herein, a pulsed detonation combustor external to the boiler is used to generate a series of detonations or quasi-detonations that are directed into the fouled portion of the boiler. The high speed shock waves travel through the fouled portion of the boiler and loosen buildup from the surface, which is then allowed to exit the boiler through hoppers. As will be discussed below, the use of repeated detonations has advantages over traditional cleaning techniques, such as steam blowers or purely acoustic soot removal devices.

It is also desirable that a cleaning system for a boiler be able to operate to quickly remove buildups in order to minimize the down-time for the boiler. In addition, it is desirable that the system be conveniently operable within the boiler environment, i.e. that it is able to physically fit within the space restrictions necessary, able to reach the portions of the boiler that require de-fouling, and that it does not interfere with the operation of the boiler when the cleaning system is not in use. It is also desirable that the installation of such cleaner not take up excessive flow space outside the boiler or require major modifications to the boiler for access. A pulse detonation combustor based cleaning system that can provide these and other features will be described in more detail below.

As used herein, the term “pulse detonation combustor” (PDC) will refer to a device or system that produces both a pressure rise and velocity increase from the detonation or quasi-detonation of a fuel and oxidizer, and that can be operated in a repeating mode to produce multiple detonations or quasi-detonations within the device. A “detonation” is a supersonic combustion in which a shock wave is coupled to a combustion zone, and the shock is sustained by the energy release from the combustion zone, resulting in combustion products at a higher pressure than the combustion reactants. For simplicity, the term “detonation” as used herein will be meant to include both detonations and quasi-detonations. A “quasi-detonation” is a supersonic turbulent combustion process that produces a pressure rise and velocity increase higher than a pressure rise and velocity increase produced by a sub-sonic deflagration wave.

Exemplary PDCs, some of which will be discussed in further detail below, include an ignition device for igniting combustion of a fuel/oxidizer mixture, and a detonation chamber in which pressure wave fronts initiated by the combustion coalesce to produce a detonation wave. Each detonation or quasi-detonation is initiated either by an external ignition source, such as a spark discharge, laser pulse, heat source, or plasma igniter, or by gas dynamic processes such as shock focusing, auto ignition or an existing detonation wave from another source (cross-fire ignition). The detonation chamber geometry allows the pressure increase behind the detonation wave to drive the detonation wave and also to blow the combustion products themselves out an exhaust of the PDC.

Various chamber geometries can support detonation formation, including round chambers, tubes, resonating cavities and annular chambers. Such chambers may be of constant or varying cross-section, both in area and shape. Exemplary chambers include cylindrical tubes and tubes having polygonal cross-sections, such as, for example, hexagonal tubes. As used herein, “downstream” refers to a direction of flow of at least one of fuel or oxidizer.

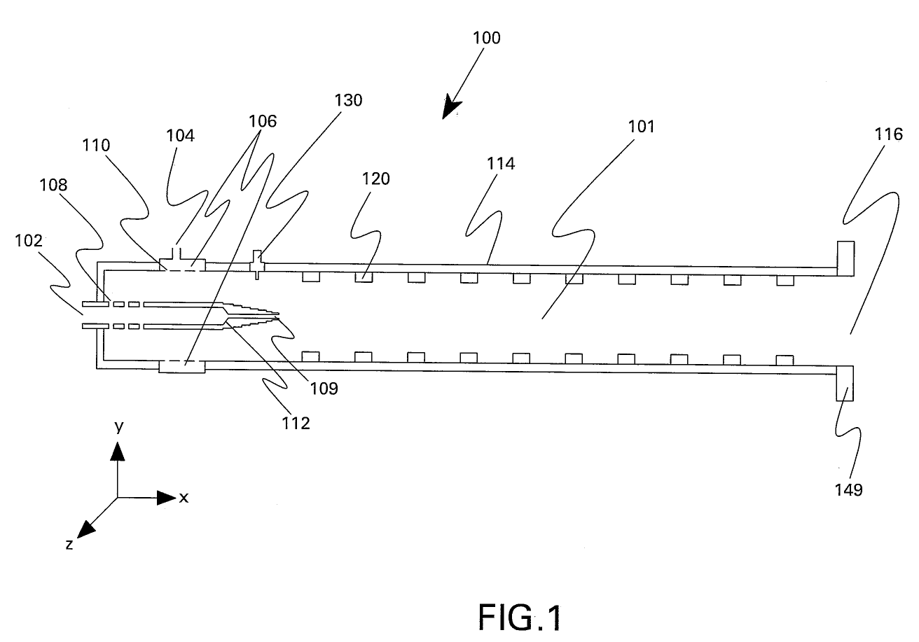

One embodiment of an exemplary PDC-based cleaning device suitable for use with an industrial boiler is illustrated schematically in FIG. 1. The PDC cleaner 100 extends along the illustrated x-axis from an upstream head end that includes inlets for air and fuel (102 and 104, respectively) located on the left side of the Figure, to an exit aperture 116 at the downstream end shown on the right side of the Figure. A tube 114 extends from the head end to the aperture 116, defining a combustion chamber 101 within it. In the illustrated embodiment, the aperture 116 of the PDC is attached to the wall 149 of the boiler to be cleaned or another downstream component that can be used to enhance the cleaning operation, as will be discussed in greater detail below.

As noted above, the head end of the illustrated PDC includes an air inlet 102. The air inlet 102 may be connected to a source of air that can be provided to the PDC under pressure. This air source is used to fill and purge the combustion chamber 101, and also provides air to serve as an oxidizer for the combustion of the fuel. In particular embodiments, the supply to air inlet 102 may be connected to a facility air source such as an air compressor. As will be discussed below with respect to the operation of the PDC, the flow through the air inlet will generally enter the tube 114 and flow the length of the combustion chamber 114 and exit downstream through the aperture 116.

The air inlet 102 of the illustrated embodiment is connected to a centerbody 112 that extends along the axis of the tube 114 and into the combustion chamber 101. The centerbody of the illustrated embodiment is a generally cylindrical tube that extends from the air inlet 102 and tapers to a downstream opening 109. In addition to the downstream opening 109, the centerbody 112 also includes one or more holes 108 along its length that allow the air flowing through the centerbody 112 to enter the upstream end of the chamber 101. These holes connect the interior of the centerbody with the annular space formed between the centerbody and the upstream portion of the tube 114.

The opening 109 and the holes 108 of the centerbody 112 allow for directional velocity to be imparted to the air that is fed into the tube 114 through the air inlet 102. Such directional flow can be used to enhance the turbulence in the injected air and to improve the mixing of the air with fuel present within the flow in the head end of the PDC. In order to enhance these effects, the holes 108 may be disposed at multiple angular and axial locations about the axis of the centerbody. In some embodiments, the angle of the holes may be purely radial to the axis of the centerbody. In other embodiments, the holes may be angled in the axial and circumferential directions so as to impart a downstream or rotational velocity to the flow from the centerbody. The flow through the centerbody also serves to provide cooling to the centerbody in order to prevent excessive heat buildup that could result in degradation of the centerbody.

In addition to the air inlet 102, a fuel inlet 104 is disposed on the head end of the PDC cleaner 100 illustrated in FIG. 1. The fuel inlet 104 is connected to a supply of fuel that will be burned within the combustion chamber 101. A plenum 106 is connected to the fuel inlet 104. In the illustrated embodiment, the plenum 106 is a cavity that extends around the circumference of the head end of the PDC. A plurality of holes 110 connect the interior of the plenum 106 with the interior of the tube 114. Fuel is supplied to the plenum 106 via the fuel inlet 104, and is then distributed around the circumference of the PDC where it enters the tube 114 through the holes 110. The holes 110 extend generally radially from the plenum 106 into the annular space between the wall of the tube 114 and the centerbody 112.

The fuel is injected into the chamber 101 and mixes with the air flow coming through the holes 108 of the centerbody 112. The mixing of the fuel and air may be enhanced by the relative arrangement of the air holes 108 and the fuel holes 110. For instance, by placing the fuel holes 110 at a location such that fuel is injected into regions of high turbulence generated by the flow through the air holes 108, the fuel and air may be more rapidly mixed, producing a more readily detonable fuel/air mixture. As with the air holes 108, the fuel holes 110 may be disposed at a variety of axial and circumferential positions. In addition, the holes 110 may be aligned to extend in a purely radial direction, or may be canted axially or circumferentially with respect to the radial direction.

Fuel may be supplied to the fuel plenum 106 through the inlet 104 through a valve that allows for the active control of when fuel is allowed into the PDC. Such a valve may be disposed within the inlet 104, or may be disposed upstream in a supply line that is connected to the fuel inlet. In one embodiment of the system, the valve may be a solenoid valve, and may be controlled electronically to open and close in order to regulate the fuel flow.

As seen in FIG. 1, an ignition device 130 is disposed near the head end of the PDC. In the illustrated embodiment, the ignition device is located along the wall of the tube 114 at a similar axial position to the end of the centerbody 112. This position allows for the fuel and air coming through holes 110 and 108 respectively to mix prior to flowing past the ignition device. As noted above, the ignition device may take various forms as known in the art. In particular, the device need not produce immediate detonation in the fuel/air mixture in every embodiment. However, the ignition device 130 desirably provides a robust enough combustion ignition that allows the combustion of the fuel/air mixture can transition to a detonation within the chamber 101, as will be discussed further below. The ignition device 130 may be connected to a controller in order to operate the ignition device at desired times.

Although not illustrated, such a controller may be used as is generally known in the art to control the timing and operation of various systems, such as the fuel valve and ignition source. As used herein, the term controller is not limited to just those integrated circuits generally referred to in the art as a controller, but broadly refers to a processor, a microprocessor, a microcontroller, a programmable logic controller, an application specific integrated circuit, and other programmable circuits suitable for such purposes.

The embodiment of a PDC illustrated in FIG. 1 includes a tube 114 that generally extends along the x-axis from the head end described above to an aperture 116 at the downstream end of the tube. The combustion chamber 101 is defined by the walls of the tube, and the combustion of the fuel/air mixture takes place within the chamber 101. In general, the combustion will progress from the ignition device 130 through the mixture that is within the combustion chamber 101. FIG. 1 illustrates a cross-section of tube in the shape of a substantially round cylinder having a constant cross-sectional area. Those of skill in the art will recognize that other configurations are also possible, as noted above.

The tube 114 contains a number of obstacles 120 disposed at various locations along the length of the tube. The obstacles 120 are used to enhance the combustion as it progresses along the length of the tube 114, and to accelerate the combustion front into a detonation or quasi-detonation before the combustion front reaches the aperture 116 at the downstream end of the tube. The obstacles 120 in the embodiment illustrated in FIG. 1 are thermally integrated with the wall of the tube 114. Such thermally integrated obstacles may be created in various ways. For example, obstacles may include features that are machined into the wall, formed integrally with the wall (by casting or forging, for example), or attached to the wall, for example by welding. In general, a thermally integrated obstacle or other thermally integrated feature of the wall is in sufficient contact with the wall of the tube that the features or obstacles 120 exchange heat effectively with the wall of the tube 114 to which they are integrated.

The tube 114, obstacles 120 and centerbody 112 may be fabricated using a variety of materials suitable for withstanding the temperatures and pressures associated with the repeated detonations. Such materials include but are not limited to: Inconel, stainless steel, aluminum and carbon steel.

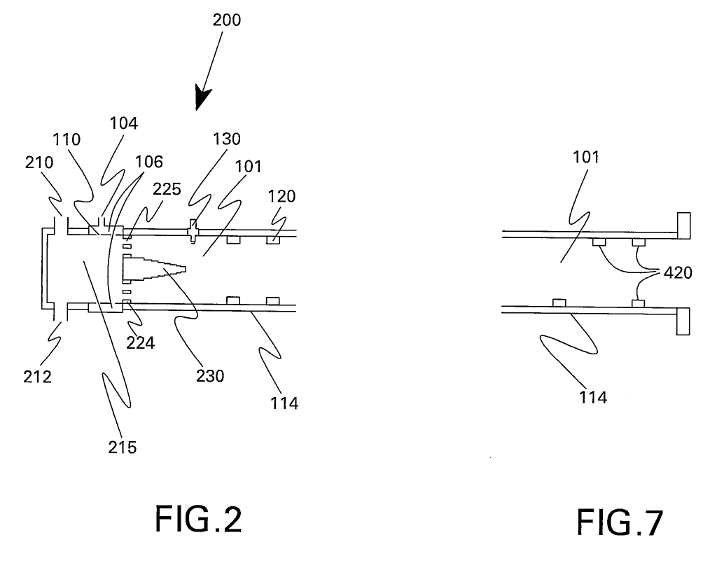

FIG. 2 illustrates an alternative head end that could be used with a PDC in another embodiment of a PDC-based cleaner. The head end 200 includes a fuel inlet 104 and plenum 106 having holes 110 that are each structured and operate in substantially the same manner as that described with respect to the embodiment shown in FIG. 1. However, rather than air being introduced through an air inlet that is directly connected to the centerbody, the head end 200 shown in FIG. 2 has air and fuel both being directly introduced into a mixing chamber 215 located upstream of a perforated plate 224.

Air inlets 210, 212 are used to introduce airflow into the mixing chamber 215 shown in FIG. 2. Each air inlet can be connected to a source of air, as with air inlet 102 in FIG. 1. Fuel is expelled from the holes 110 from the plenum 106 into the mixing chamber 215 as well. The fuel and air begin mixing in the mixing chamber 215 before they flow through holes 225 in the perforated plate 224 that separates the mixing chamber 215 from the combustion chamber 101. As the fuel/air mixture is expressed through the holes 225 of the plate 224, additional turbulence is created in the flow, further enhancing the fuel/air mixing.

The fuel/air mixture enters the upstream portion of the combustion chamber 101 after passing through the perforated plate 224, and flows around a centerbody 230 that can be mounted upon the plate 224. This pre-mixed flow can them be ignited by an ignition device 130, much as described above with respect to FIG. 1. The head end 200 illustrated in FIG. 2 can be used in place of the head end features described above, or with the variations of the PDC that are described below.

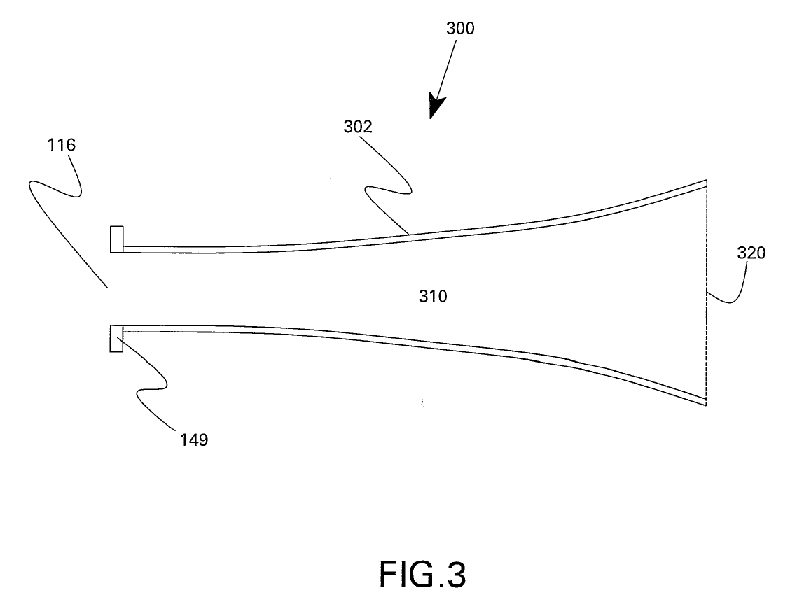

FIG. 3 shows an embodiment of a diverging chamber that can be connected downstream of a PDC system, such as that shown in FIGS. 1 and 2, and that would receive the flow from the aperture 116 of the combustion chamber 101 of the PDC. In the illustrated embodiment, the diverging chamber 300 is connected directly to the exit aperture 116 of the PDC, and the wall 149 of the downstream device shown in FIG. 1 is the upstream wall 149 of the diverging chamber 300. Those of skill in the art will recognize that although the diverging chamber need not be in direct contact with the PDC, it is desirable that the chamber 101 of the PDC is in flow communication with the diverging chamber 300.

As shown in FIG. 3, the exemplary diverging chamber 300 has walls 302 that enclose a flow path 310. The illustrated walls form a horn or bell shape that produces an increase in the cross-sectional area of the flow path 310 from the upstream end (connected to the aperture 116) to the downstream exit 320 from the chamber 300. The increased cross-section as the flow travels downstream serves to increase the volume of fuel and air that can be combusted within the PDC cleaner during each combustion cycle. This can be used to increase the penetration and effectiveness of the shock waves produced.

The illustrated diverging chamber 300 provides a gradually diverging flow path 310, as opposed to an abrupt change in volume that the flow path would experience if vented directly into a larger chamber. This gradual divergence allows for the detonation produced by the PDC to be sustained as it travels through the diverging flow path 310 of the chamber without causing a failure of the detonation.

The inner surface of the walls 302 of the illustrated diverging chamber 300 are smooth and substantially circular in cross-section normal to the axis of the chamber. Those of skill in the art will appreciate that other cross sectional shapes are also possible, as well as other axial profiles for the diverging chamber. In alternative embodiments of the diverging chamber, obstacles similar to those described herein for use in DDT within the PDC chamber 101 can be disposed within the flow path 310 of the diverging chamber 300. Such obstacles (not shown) can be used to promote flame acceleration and DDT as the detonation propagates through the expanding profile of the chamber 300.

In one particular embodiment of a diverging chamber, the chamber was formed from a 60 inch (approximately 1.52 meters) long chamber 300 of circular cross section in which the diameter increased from 2 inches (approximately 50.8 millimeters) at the upstream side to a diameter of 19 inches (approximately 482.6 millimeters) at the exit 320. With detonations produced using an ethylene/air mixture in an upstream PDC, detonations could be maintained at frequencies up to 20 Hz.

As noted above, the PDC-based cleaning system uses the detonations produced by a PDC to loosen debris and coatings that can accumulate on the walls of a boiler or other device, and then the high pressure flow that follows the detonation to help blow the loosened material away from the surface. In operation, the PDC creates a detonation and its associated high-pressure flow via a combustion cycle, which is repeated at high frequency. PDCs can often be operated at frequencies of 1-100 Hz. Each combustion cycle generally includes a fill phase, an ignition event, a flame acceleration into detonation phase, and a blowdown phase. The general operation of the PDC and cleaner will be discussed with reference to the Figures in greater detail below.

In the discussion that follows, a single occurrence of a fuel fill phase, a combustion ignition, an acceleration of the flame front to a detonation, and the blow down and purge of the combustion products will be referred to as “a combustion cycle” or “a detonation cycle”. The portion of time that the cleaner system is active is referred to as “cleaner operation”. Time when the vessel to be cleaned is being actively used for its purpose will be referred to as “boiler operation”. As noted above, the vessel to be cleaned need not be part of a boiler; however, for simplicity of reference, the term “boiler operation” will be used to refer to the operation of any device being cleaned by the cleaner device.

In particular, as will be discussed below, one advantage of the system described herein is that, unlike other detonation cleaner systems, there is no need to shut down the boiler or other device whose vessel is being cleaned in order to operate the cleaner. Specifically, it is possible for the cleaner operation to take place during the boiler operation. The cleaner need not be run continuously during the boiler operation; however, by providing the flexibility to operate the cleaner on a regular cycle during boiler operation, an overall higher level of cleanliness can be maintained without significant down-time in boiler operation.

In the fill phase of the detonation cycle, air and fuel are fed into the PDC. As shown in FIG. 1 and discussed above, air can be introduced via the air inlet 102, and fuel through the fuel inlet 104, after which the fuel and air will mix as described to form a fuel/air mixture suitable for combustion within the PDC. As more fuel and air are introduced and mixed, the chamber will tend to fill with the fuel/air mixture, starting near the head end in the illustrated embodiment, and proceeding along its length as more fuel and air are introduced. As discussed above, air can be fed continuously to the PDC through the air inlet 102 during cleaner operation, but it may be desirable to use a valve to control the introduction of fuel into the PDC by means of a controller in some embodiments. In addition, the ability to control the flow of air for times when the cleaner is not operating may also be desirable. In one exemplary embodiment, a controller can track the amount of time that has passed since the opening of a fuel valve and, based upon the rate of air input to the PDC, can close the fuel valve one a sufficient amount of fuel has been added that the fuel/air mixture has filled the desired portion of the combustion chamber 101.

After the combustion event, air continues to be introduced into the chamber 101 during combustor or cleaner operation to assist in purging any remaining combustion products from the previous combustion cycle. In varying embodiments, the valve may be used to provide a greater or lesser amount of fuel that would be required to fill the chamber in order to tune the operation of the PDC. Once the valve is closed and the chamber is no longer being fueled, the ignition device 130 is activated.

The ignition device 130 may be triggered by a controller in order to initiate the combustion of the fuel/air mixture within the chamber 101. If, for example, a spark initiator is used as the ignition device, the controller can send electrical current to the initiator in order to create a spark at the appropriate time. In general, the ignition device introduces sufficient energy into the mixture near the ignition device to form a flame within the fuel/air mixture near the device 130. As this flame consumes the fuel by burning it with the oxidizer present in the mixture, the flame will propagate through the mixture within the chamber 101.

As the flame propagates through the chamber 101 of the PDC, the flame front will reach the walls of the tube 114 and the obstacles 120 that are disposed within the tube. The interaction of the flame front with the walls of the tube and the obstacles will tend to generate an increase in pressure and temperature within the chamber. Such increased pressure and temperature tend to increase the speed at which the flame propagates through the chamber and the rate at which energy is released from the fuel/air mixture by the combustion at the flame front. This acceleration continues until the combustion speed raises above that expected from an ordinary deflagration process to a speed that characterizes a quasi-detonation or detonation. This DDT process desirably takes place rapidly (in order to sustain a high cyclic rate of operation), and so the obstacles 120 are used to decrease the run-up time and distance that is required for each initiated flame to transition into a detonation.

The detonation wave travels down the length of the tube 114 and out of the exit aperture 116 of the tube. From the aperture 116, the detonation wave may be directed into the body of an object to be cleaned, or may be sent through a diverging section 300 such as that illustrated in FIG. 3 prior to being directed into the object to be cleaned. High pressure combustion products follow the detonation wave and blow through the exit aperture 116 along with the detonation wave itself.

As the high-pressure products blow out of the PDC, the continued supply of air through the air inlet 102 will tend to push the products downstream and out of the aperture 116, even as the pressure within the combustion products drops. Such continued supply of air is used to purge the combustion products from the tube 114. Once the combustion products are purged, the valve for the fuel inlet 104 may be opened, and a new fill phase may be started to begin the next combustion cycle.

The detonation wave that exits from the tube 114 or exit of the diverging chamber 320 includes an abrupt pressure increase, or shock, that will propagate through the body of the object to be cleaned. This shock can have several beneficial effects in removing debris and slag from surfaces such as boiler walls. In one aspect, the shock wave can produce pressure waves that travel through the accumulated slag and debris. Such internal pressure waves can produce flexing and compression within the accumulations that can enhance crack formation within the debris and break portions of the debris away from the rest of the accumulation, or from the boiler walls. This is often seen as “dust” that is liberated from the surface of the of the accumulated slag. In addition, the pressure change associated with the passage of the shock can produce flexion in the walls of the boiler itself, which can also assist in separating the slag from the walls. In addition, the repeated impacts from the subsequent shocks of repeating combustion cycles may excite resonances within the slag that can further enhance the internal stresses experienced and promote the mechanical breakdown of the debris. Behind each shock, the flow of pressurized combustion products provides a sweeping effect that can blow loosened debris and particles downstream. The repeated action of shock and purge is used to erode build-up that accumulates upon the boiler walls.

In order to optimize the cleaning effect, the strength of each wave existing from the PDC can be increased or decreased, as can the operational frequency at which the PDC is operated. The strength and frequency can be adjusted by alterations in both design and operational parameters. For instance, changes in the length of the chamber 101 can be used to alter the amount of run-up time needed for DDT, or the use of various lengths or shapes of diverging chamber 300 can be used in order to achieve different levels of pressure in the shock. Operationally, variations can be made in the amount of fuel-fill by controlling the duration for which the fuel valve remains open, or the rate or pressure at which air or fuel is introduced into the PDC through the air and fuel inlets 102, 104.

By altering the choice of fuel or operational frequency, the overall operational reliability and cleaning effectiveness can be further tuned for the particular geometry or debris accumulations experienced. In one embodiment of a cleaner as described herein, the fuel used is a gaseous fuel, such as ethylene. In particular embodiments, it should be noted that the fuel need not be stored in a gaseous form, but may be in a gaseous form at the time of introduction into the combustion chamber 101 through the fuel inlet. Other possible fuels include but are not limited to: other gaseous fuels including hydrogen gas, natural gas, methane, and propane; and liquid fuels including gasoline, kerosene and aviation fuels.

For example, experiments were conducted at up to 20 Hz using an embodiment with a head end 200 as shown in FIG. 2 firing into a tube 114 as shown in FIG. 1. Ethylene was used for fuel and air was used as oxidizer. Test results showed that the downstream measured pressure (as would be experienced inside a boiler being cleaned) was strongly dependent upon the duration of the filling phase, and the effective volume of the chamber 101 that was filled. Varying the effective fuel-filled length of the chamber between 20 inches (approximately 508 millimeters) from the inlet to 90 inches (approximately 2.29 meters) from the inlet created a significant variation in the peak pressure measured downstream during operation of the PDC.

In addition to variations in fuel, variations may also be made to the oxidizer used. Although the term “air” is used throughout, those of skill in the art will understand that an appropriate combustible mixture may be formed through the use of oxidizers other than air. In a particular embodiment, air is used as the oxidizer because it is generally conveniently available and avoids the expense and complication of providing a separate oxidizer supply. In addition, the use of air allows for continuous purging of the PDC cleaner to more effectively cool the system between combustion cycles.

In addition, the systems described are capable of operating such that detonations can be produced with the use of the same oxidizer, such as air, for the initial ignition of the combustion within the chamber, as well as the run-up of the combustion into a detonation, and the support of the detonation itself. This allows for a simpler system that does not require separate sources of oxidizer, or the injection of oxidizer at different pressures or concentrations into the combustion chamber at various points.

Similarly, the use of a single fuel system for both the initial combustion, the run-up, and the detonation, allows for a simpler system than one that uses separate fueling of the various portions of the system (for instance, one fueling system for the initial combustion and run-up, and a second fueling system for a main detonation chamber). In addition to using the same fueling system, the systems described herein make use of the same fuel for initiation, run-up and detonation.

It will be understood that other alterations may be made to aspects of the systems and operational methods described while retaining the benefits shown. For instance, in one alternative aspect, multiple air inlets 102 may be used in order to allow for a more rapid introduction of air into the PDC. In other alternative aspects, multiple fuel inlets 104 may be used, either feeding a single fuel plenum 106, or feeding separate plenums that independently inject fuel into the combustion chamber 101 or mixing chamber 215. Further possible variations include the use of multiple ignition devices 130, spaced radially or axially along the head end or the combustion chamber 101.

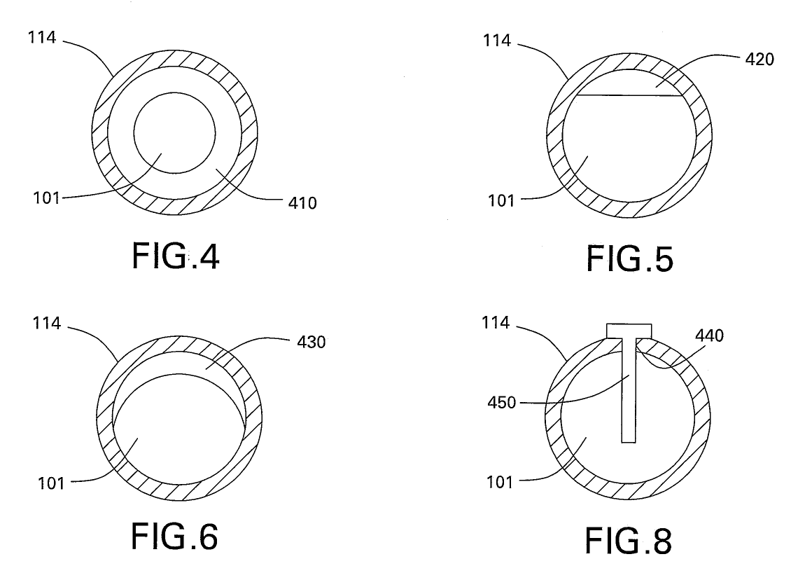

Another example of variation can be found in the configuration of the obstacles 120 discussed above with respect to FIG. 1. Obstacles may be in various forms suitable for improving the DDT process and reliability operating within the PDC environment. In one aspect, the obstacles 120 may take the form of annular rings 410 that extend from the walls 114 of the tube, as shown in FIG. 4. Such rings 410 provide a restriction in the cross-sectional area of the tube, and a surface for the flame front to partially reflect off of. Other forms may include partial obstructions, such as circular segments 420, for example a half-moon as shown in FIG. 5, or crescent shaped plates 430 as shown in FIG. 6. Such forms may be plates that extend from the surface of the tube 114.

The spacing and placement of obstacles 120 may also be varied in order to produce more effective cleaning detonations from the PDC. For instance, rather than being spaced equally as shown in FIG. 1, obstacles 120 may be placed with varying distances between successive obstacles 120 along the length of the tube 114. In addition, for obstacles 120 such as the circular segment 420, crescent 430, or other obstacles that are not rotationally symmetrical about the axis of the tube 114, varying circumferential placements are possible. For example, obstacles 120 with a circular segment shape 420 may be placed on alternating sides of the tube 114 along the length, such that successive obstacles 120 are disposed opposite one another as shown in FIG. 7. In addition, placement of multiple obstacles at the same axial position along the tube 114 is also possible for obstacles that do not span the entire area of the tube. One example of such a placement of multiple circular segments is shown on the right side of FIG. 7.

In another embodiment, the obstacles take the form of a cylindrical protrusion that extends from the wall of the tube into the combustion chamber. As shown in the cross-sectional axial view of FIG. 8, a hole 440 is created in the tube 114 of the PDC. A cylinder 450 is then placed through the hole 440 and extends through the wall of the tube 114 and into the combustion chamber 101. In one embodiment, the cylinder 450 is threaded, as is the hole 440, and the cylinder is held in place by the threading between the cylindrical bolt and hole. In other embodiments the protrusion is secured in position by welding or other mechanical restriction. It will be understood that the cylindrical protrusion can also be formed via casting or being integrally formed with the wall of the tube. Such an arrangement can be used to thermally integrated the bolts with the walls of the tube 114 as discussed above.

As shown in FIG. 8, the cylinder 450 extends into the combustion chamber 101. The length which the cylinder extends into the chamber can vary in different embodiments of the systems described herein. For instance, in one embodiment, the length may be greater than or equal to about one-half of the inner diameter of the combustion chamber. In another embodiment, the length may be equal to the inner diameter of the combustion chamber, in which case the cylinder will extend to the opposite side of the chamber from the side from which it extends. In varying embodiments, the ratio of the length which the cylinder extends from the wall of the chamber to the inner diameter of the combustion chamber at the location of the cylinder may be: from about 0.5 to about 0.625; from about 0.625 to about 0.70; from about 0.70 to about 0.80; from about 0.80 to about 0.875; from about 0.875 to about 0.95; or from 0.95 to about 1. In a particular embodiment, the cylinder may have an extending length of about 1.5 inches (about 38.1 millimeters), and the inner diameter may be about 2.0 inches (about 50.8 millimeters), for a ratio between the length and the inner diameter of about 0.75. Other embodiments will be described below.

As can also be seen with reference to FIG. 8, the cylinder 450 also has a width, or diameter, which may vary in different embodiments of the systems described herein. For instance, in one embodiment, the width of the cylinder 450 may be greater than or equal to about one-quarter of the inner diameter of the combustion chamber 101. In another embodiment, the width may be less than or equal to about one-half of the inner diameter. In varying embodiments, the ratio of the width of the cylinder to the inner diameter of the combustion chamber at the location of the cylinder may be: from about 0.25 to about 0.30; from about 0.30 to about 0.40; from about 0.40 to about 0.45; and from about 0.45 to about 0.5. In a particular embodiment, the cylinder may have a width of about 0.625 inches (approximately 15.9 millimeters), and the combustion chamber may have an inner diameter of about 2.0 inches (approximately 50.8 millimeters), for a ratio between the width of the cylinder and the inner diameter of about 0.3125. Other embodiments will be described below.

Here and throughout the specification and claims, range limitations such as those recited above may be combined and/or interchanged and such ranges identified can include all the sub-ranges contained therein unless context or language indicates otherwise.

In another particular embodiment, the DDT portion of the tube 114 is made up from a steel tube with a 2 inch (approximately 50.8 millimeters) outer diameter with a length of 40 inches (1.02 meters) between the head end ignition device 130 and the exit aperture 116. Obstacles 120 were placed every 2 inches (approximately 50.8 millimeters) along the length of the DDT section, and each obstacle 120 was a ½ inch diameter (about 12.7 millimeters) threaded bolt 450 driven through a hole 440 in the wall of the tube 114 and protruding 1.25 inches (about 31.75 millimeters) into the combustion chamber 101. Each bolt 450 was located circumferentially at a position approximately 90 degrees from the bolt disposed immediately upstream, creating a spiral configuration of bolts that extended along the length of the tube 114.

In testing, it was found that the use of cylindrical protrusions, such as bolts, provided a high degree of robustness of operational parameters that could be used to support detonation. For example, the use of bolts allowed for variation in the overall air/fuel ratio that was present within the combustion chamber at the time of ignition, while still allowing the combustion to transition to detonation. Such variations in the fuel/air ratio can be achieved by varying the duration of the fuel fill used prior to each ignition, thereby varying the fraction of the overall chamber that is filled with fuel. Such variations may also be achieved by changing the rate at which air or fuel is introduced into the system.

During operation of a PDC, the heat and pressure produced inside the combustion chamber can have a damaging effect on the surface of the combustion chamber 101. In particular, the obstacles 120 that extend into the flow may be heated significantly during combustion. Having thermally integrated obstacles assists in the transfer of heat form the obstacles into the tube 114 itself. Because the tube is only heated from one side, and can also be externally cooled, the tube 114 can be used as a heat sink to dissipate heat that is transferred to thermally integrated obstacles 120. Such thermally integrated obstacles will remain cooler during operation and will therefore remain stronger and less liable to failure than non-thermally integrated obstacles.

In addition to assisting in transition from deflagration to detonation within the combustion chamber, obstacles 120 in the form of bolts 450 as shown in FIG. 8 may also be removed from the tube 114 and replaced if they become damaged from extended operation. Because such a removable obstacle can be replaced prior to failure, degradation of performance of the PDC can be avoided without the need to replace entire sections of the PDC tube 114.

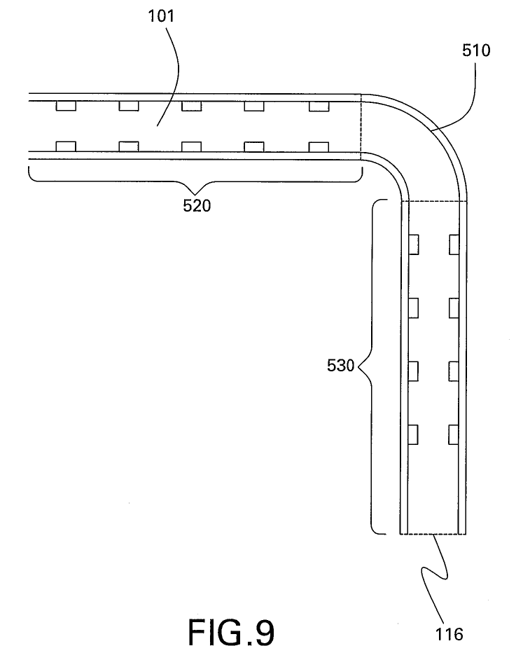

In addition to the configurations discussed above, other configurations and arrangement of the components illustrated can be used in creating appropriate PDC-based cleaning systems. For instance, although tube 114 is illustrated as extending substantially linearly along the x-axis in FIG. 1, in an alternative embodiment, such as that shown in FIG. 9, the tube could contain a bend 510 along its length that separates a first section 520 of the tube from a second section 530 of the tube. In such an arrangement, the second section 530 is not coaxial with the first section 520. Such an arrangement may include obstacles 120 disposed in one or more of the first section 520, second section 530 and bend 530. This configuration creates a combustion chamber 101 that extends along the curved path of the tube from the head end to the exit aperture 116. As with straight tubes, PDC embodiments with bends 530 may optionally be connected to diverging chambers 300 or other downstream components, or may exit directly into the device to be cleaned.

In another embodiment, a bend may be located in a diverging chamber, such that the diverging chamber is divided into a first section and a second section which are not co-axial. As discussed above with respect to FIG. 9, such arrangements may include obstacles in one or more of the first section of the diverging chamber, the second section of the diverging chamber, or the bend of the diverging chamber. In addition, the bend itself may be of a diverging cross-sectional area.

In yet other embodiments, a bend may be placed between the PDC and one or more downstream devices. For example, in a particular embodiment, a bend may be disposed between the aperture 116 of a combustion chamber and a diverging chamber 300. In addition to providing for more flexibility in the packaging of the components of PDC-cleaner systems, bends along the length of the flow path may provide gas dynamic benefits in maintaining the strength and development of a detonation wave as it passes through such a curved flow path.

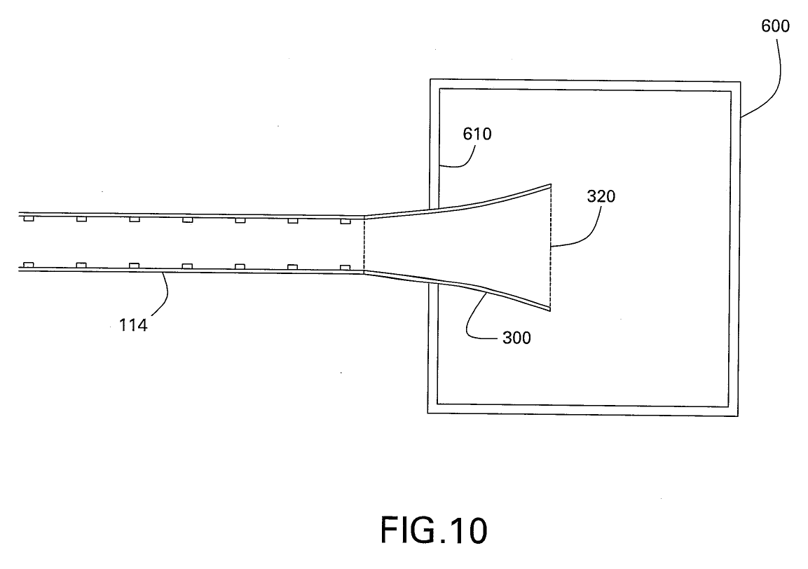

In another alternate configuration, a portion of the PDC cleaner may be disposed within the vessel to be cleaned. For instance, FIG. 10 illustrates a schematic view of a PDC-cleaner having a straight tube 114 that is connected to a diverging chamber 300. However, rather than the exit 320 of the diverging chamber being disposed flush with the wall 610 of an exemplary boiler 600, a portion of the diverging chamber is disposed within the boiler 600 such that the diverging chamber 300 extends away from the wall 610.

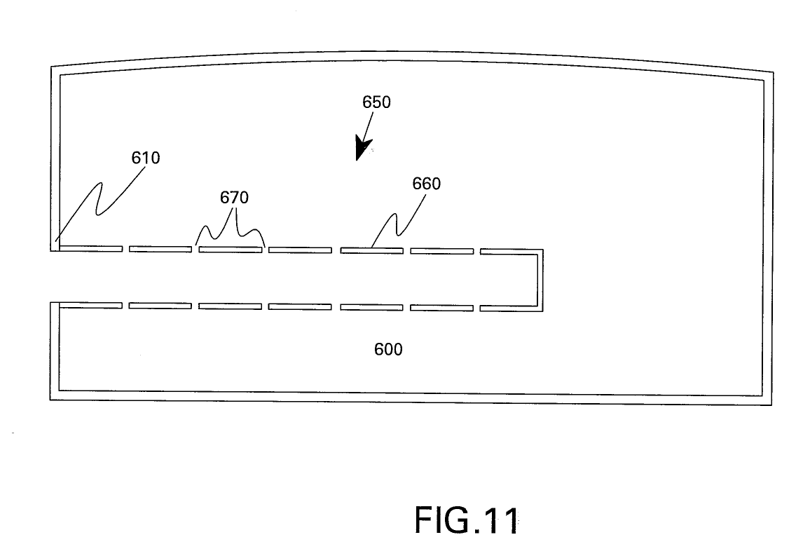

Another alternate configuration for a downstream device for use with the PDC cleaners described herein is shown in FIG. 11. A multiple exit chamber 650 is illustrated schematically. Such a chamber 650 is formed from walls 660 that extend into the vessel to be cleaned 600 away from the wall 610 of the vessel itself. The flow from the PDC is directed into the multiple exit chamber 650 through a hole in the wall 610 of the vessel. A plurality of exit holes 670 are disposed in the walls 660 of the chamber 650 through which the detonation wave and pressurized flow from the PDC may be directed into the vessel 600. Such an arrangement can be used to more particularly direct and localize the output from the PDC for more effective cleaning of specific surfaces within the vessel.

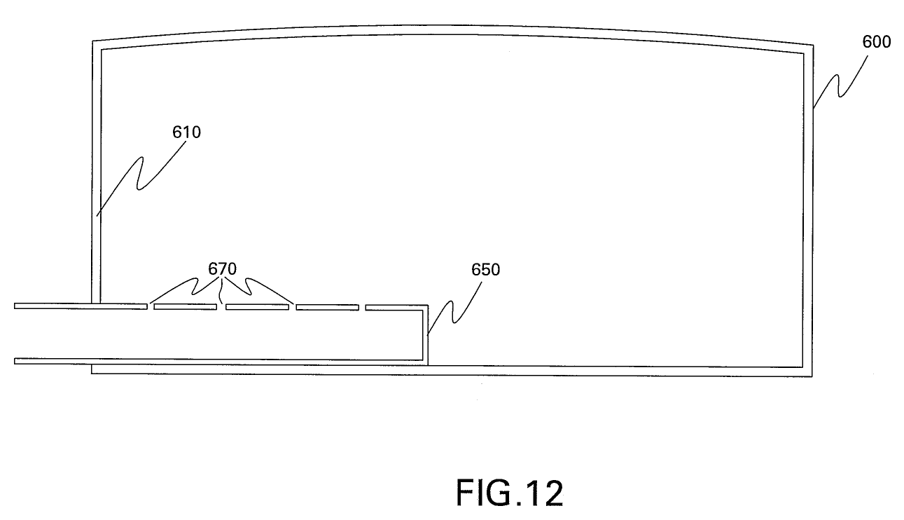

In the illustrated embodiment, the multiple exit chamber 650 extends into the vessel 600 from a wall 610 on the side of the vessel. However, in other embodiments, the multiple exit tube could be disposed along a wall 610 of the vessel such that the holes 670 are used to direct the detonations from the PDC at multiple locations along the wall, as shown in FIG. 12.

It will also be appreciated that such cleaning systems are not limited to industrial boilers, but may be used to provide cleaning on a variety of different surfaces which may experience fouling. Examples of vessels having surfaces which may be cleaned using the systems and techniques described herein include but are not limited to: vessels used in cement production, waste-to-energy plants, and coal-fired energy facilities, as well as reactors in coal gasification plants.

Other features that may be used in varying embodiments of the systems described herein include area reduction devices that may be disposed within the combustion chamber 101 or downstream devices such as the diverging chamber 300 or multiple exit chamber 650. Such area reduction devices may include but are not limited to nozzles and venturis, and may be used to increase the pressure within the various chambers or to reflect shocks in order to enhance detonation transition and propagation. Such devices may be integrally formed with the chamber walls, for instance by machining, or may be attached to the chambers via techniques such as frictional fitting, bolting or welding.

In addition to varying the configuration of the cleaner, as described above, the duration and frequency of the combustion cycles and the cleaner operation can also be varied. For instance, in a particular embodiment, the cleaner may be activated for about 2 seconds during each minute of boiler operation. During these two seconds of operation, the cleaner may operate at a detonation cycle frequency of about 2 Hz. In such a system, a small number of detonations are used over a short period of time each minute to shake loose accumulated debris.

In another embodiment, cleaner operation is used for about one minute, followed by a minute of non-operation in order to allow the cleaner to cool down. Such a one-minute-on, one-minute-off cycle of cleaner operation is repeated for a period of time, such as 30 minutes. This operation may be executed once per day, or as needed during continuous boiler operation. The frequency of the detonation cycle may be fixed at 2 Hz, as in the previous example, or may be raised or lowered as desired. Those of skill in the art will recognize that a variety of configurations of cleaner operation duty cycles are possible, making use of a variety of detonation cycle frequencies, without deviating from the teachings herein.

In a particular embodiment, the combustor of the cleaner is operated at a frequency greater than or equal to about 1 Hz. In another embodiment, the detonation cycle frequency is less than or equal to about 100 Hz. In varying embodiments, the detonation cycle frequency may be: from about 1 Hz to about 1.5 Hz; from about 1.5 Hz to about 2.5 Hz; from about 2.5 Hz to about 4 Hz; from about 4 Hz to about 8 Hz; from about 8 Hz to about 12 Hz; from about 12 Hz to about 18 Hz; from about 18 Hz to about 25 Hz; from about 25 Hz to about 40 Hz; and from about 40 Hz to about 100 Hz. In particular embodiments, the detonation frequency is: about 2 Hz; about 3 Hz; about 10 Hz; and about 20 Hz.

The various embodiments of cleaning systems described above thus provide a way to achieve soot or ash removal from a boiler or other vessel. These techniques and systems also allow for periodic operation without the need to shut down the device being cleaned for extended periods of time.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of bolts as obstacles described with respect to one embodiment can be adapted for use with diverging chambers described with respect to another. Similarly, the various features described, as well as other known equivalents for each feature, can be mixed and matched by one of ordinary skill in this art to construct additional systems and techniques in accordance with principles of this disclosure.

Although the systems herein have been disclosed in the context of certain preferred embodiments and examples, it will be understood by those skilled in the art that the invention extends beyond the specifically disclosed embodiments to other alternative embodiments and/or uses of the systems and techniques herein and obvious modifications and equivalents thereof. Thus, it is intended that the scope of the invention disclosed should not be limited by the particular disclosed embodiments described above, but should be determined only by a fair reading of the claims that follow.

1. A system for removing accumulated debris from a surface within a vessel, the system comprising:
a vessel having a surface to be cleaned;
a fuel source providing a combustible fuel;
an air source providing a flow of air;
a pulse detonation combustor, comprising:
a combustion chamber having a wall defining an airflow path from an upstream end toward a downstream end;
an air inlet disposed upon the combustion chamber and connected to the air source and in flow communication with the combustion chamber;
a fuel inlet in flow communication with the combustion chamber and connected to the fuel source;
an ignition device disposed downstream of the fuel inlet that is configured to periodically ignite the fuel within the airflow and produce a flame; and
a plurality of obstacles disposed along the airflow path and configured to promote the acceleration of the flame into a detonation as it passes through the combustion chamber;
wherein the downstream end of the pulse detonation combustor is disposed on the vessel such that the shock wave associated with the detonation from the pulse detonation combustor passes over the surface to be cleaned within the vessel.

2. A system as in claim 1 wherein the vessel is part of a device that remains in operation during the operation of the combustor.

3. A system as in claim 1 wherein the frequency of operation of the combustor is greater than about 1 Hz.

4. A system as in claim 1 wherein a fuel plenum is disposed in flow communication with the fuel inlet, the fuel plenum having a plurality of holes that allow the fuel to be injected into the pulse detonation combustor through the plurality of holes.

5. A system as in claim 2 wherein the holes of the fuel plenum are disposed around a circumference of the pulse detonation combustor.

6. A system as in claim 1 wherein the air inlet is in flow communication with an interior of a hollow centerbody extending along an axis of the combustion chamber, the centerbody having a plurality of holes providing flow communication between the interior of the centerbody and the combustion chamber.

7. A system as in claim 1 wherein the air source provides a continuous supply of air to the combustion chamber through the air inlet during the operation of the combustor.

8. A system as in claim 1 wherein the air source is the only source of oxidizer for the combustion chamber.

9. A system as in claim 1 wherein the pulse detonation combustor extends into the interior of the vessel.

10. A system as in claim 1 wherein the pulse detonation combustor includes a plurality of openings that provide flow communication between the pulse detonation combustor and the interior of the vessel.

11. A system as in claim 1 wherein the pulse detonation combustor includes a diverging chamber disposed downstream of and in flow communication with the combustion chamber, the diverging chamber having a cross section that increases in the downstream direction.

12. A system as in claim 11 wherein an additional series of obstacles are disposed along the airflow path through the diverging chamber.

13. A system as in claim 11 wherein the combustion generated in the combustion chamber remains a detonation as it passes through the diverging chamber.

14. A system as in claim 1 wherein the cross-sectional area of the airflow path through the combustion chamber has a constant area.

15. A system as in claim 1 wherein the combustion chamber includes a first section and a second section and the first section is not coaxial with the second section.

16. A system as in claim 1 wherein the plurality of obstacles are thermally integrated to the walls of the combustion chamber.

17. A system as in claim 1 wherein the obstacles comprise cylindrical protrusions extending from the wall of the combustion chamber.

18. A system as in claim 17 wherein each cylindrical protrusion has a width between about one-quarter and about one-half of the inner diameter of the combustion chamber.

19. A system as in claim 17 wherein each cylindrical protrusion extends a length away from the wall of the combustion chamber a distance greater than about one-half of the inner diameter of the combustion chamber.

20. A system as in claim 17 wherein the series of obstacles are disposed at regular intervals along the length of the combustion chamber and each successive obstacle is disposed upon the wall of the combustion chamber at a position that is angularly offset from the previous obstacle.

21. A system as in claim 1 wherein the fuel passed through the fuel inlet is in gaseous form.

22. A system as in claim 1 further comprising a fuel valve disposed between the source of fuel and the fuel inlet of the pulse detonation combustor, the fuel valve operated configured to only allow fuel to flow into the combustion chamber periodically.

23. A system as in claim 1 wherein the source of air is a compressor that compresses ambient air.

24. A cleaner for removing accumulated debris from a surface of a vessel, the cleaner comprising:
a pulse detonation combustor, comprising:
a combustion chamber having a wall defining an airflow path from an upstream end toward a downstream end;
an air inlet in flow communication with the combustion chamber and configured to be connected to an air source;
a fuel inlet in flow communication with the combustion chamber and configured to be connected to a fuel source;
an ignition device disposed downstream of the fuel inlet that is configured to periodically ignite the fuel within the airflow and produce a flame; and
a plurality of obstacles disposed along the airflow path and configured to promote the acceleration of the flame into a detonation as it passes through the combustion chamber;
wherein the downstream end of the pulse detonation combustor is configured to direct the shock wave associated with the detonation in the pulse detonation combustor to pass over the surface of a vessel to be cleaned.

25. A system as in claim 24 wherein the vessel is part of a device that remains in operation during the operation of the cleaner.

26. A system as in claim 24 wherein the frequency of operation of the combustor is greater than about 1 Hz.

27. A cleaner as in claim 24 wherein the plurality of obstacles are thermally integrated to the walls of the combustion chamber.

28. A cleaner as in claim 24 wherein the obstacles comprise cylindrical protrusions disposed upon the wall of the combustion chamber.

29. A cleaner as in claim 28 wherein the series of obstacles are disposed at regular intervals along the length of the combustion chamber and wherein each successive obstacle is disposed upon the wall of the combustion chamber at a position that is angularly offset from the previous obstacle.

30. A cleaner as in claim 24 wherein a fuel plenum is disposed in flow communication with the fuel inlet, the fuel plenum having a plurality of holes that allow the fuel to be injected into the pulse detonation combustor through the plurality of holes.

31. A cleaner as in claim 24 wherein the air inlet provides a continuous supply of air to the combustion chamber from the air source during cleaner operation.

32. A cleaner as in claim 24 wherein the air inlet is in flow communication with an interior of a hollow centerbody extending along an axis of the combustion chamber, the centerbody having a plurality of holes providing flow communication between the interior of the centerbody and the combustion chamber.

33. A cleaner as in claim 24 wherein the pulse detonation combustor includes a diverging chamber disposed downstream of and in flow communication with the combustion chamber, the diverging chamber having a cross section that increases in the downstream direction.

34. A cleaner as in claim 33 wherein an additional series of obstacles are disposed along the airflow path through the diverging chamber.

35. A method for removing accumulated debris from a surface within a vessel, the method comprising:
receiving a flow of air into a combustion chamber through an air inlet, the flow of air defining a downstream direction of flow;
receiving a flow of fuel into the combustion chamber through a fuel inlet into the flow of air;
mixing the fuel and air within the combustion chamber;
periodically igniting the fuel and air mixture using an ignition device;
accelerating the flame into a detonation as it passes downstream through the combustion chamber by passing the flow over a plurality of obstacles disposed along the path of the flow of air through the combustion chamber;
directing the detonation into a vessel having a surface to be cleaned;
passing the shockwave associated with the detonation over a surface within a vessel to loosen debris from the surface; and
blowing the loosened debris from the surface.

36. A method as in claim 35 wherein the vessel is part of a device and the device is in operation during the execution of the method.

37. A method as in claim 35 wherein the steps of the method are repeated at a frequency greater than about 1 Hz.

38. A method as in claim 35 wherein the cross-sectional area of the combustion chamber along the direction of flow is constant.

39. A method as in claim 35 wherein the combustion chamber includes a first section and a second section and the first section is not coaxial with the second section.

40. A method as in claim 35 wherein the plurality of obstacles are thermally integrated to a wall of the combustion chamber.

41. A method as in claim 35 wherein the obstacles comprise cylindrical protrusions disposed upon the wall of the combustion chamber.

42. A method as in claim 41 wherein the series of obstacles are disposed at regular intervals along the length of the combustion chamber and each successive obstacle is disposed at a position that is angularly offset from the previous obstacle.

43. A method as in claim 35 wherein the flow of fuel is received into the combustion chamber in a gaseous state.

44. A method as in claim 35 wherein receiving a flow of fuel further comprises receiving the flow of fuel periodically.

45. A method as in claim 44 further comprising altering the period for which fuel is received by the combustion chamber on successive repetitions of the receiving a flow of fuel step.

46. A method as in claim 35 wherein receiving a flow of air further comprises receiving a continuous supply of air into the combustion chamber through the air inlet during the steps of the method.

47. A method as in claim 35 wherein the air inlet is in flow communication with an interior of a hollow centerbody extending along an axis of the combustion chamber, the centerbody having a plurality of holes providing flow communication between the interior of the centerbody and the combustion chamber.

48. A method as in claim 35 further comprising expanding the flow from the combustion chamber through a diverging chamber disposed downstream of and in flow communication with the combustion chamber, the diverging chamber having a cross section that increases in the downstream direction.
